(19) United States
(12) Patent Application Publication
(10) Pub. No.: US 2016/0025133 A1
(43) Pub. Date: Jan. 28, 2016

(54) FOUR SEGMENT CONTACT THRUST ROLLER BEARING

(71) Applicant: Schaeffler Technologies AG & Co. KG, Herzogenaurach (DE)

(72) Inventor: Aditya Dattawadkar, Wooster, OH (US)

(73) Assignee: SCHAEFFLER TECHNOLOGIES AG & CO. KG, Herzogenaurach (DE)

(21) Appl. No.: 14/739,258

(22) Filed: Jun. 15, 2015

Related U.S. Application Data
(60) Provisional application No. 62/029,716, filed on Jul. 28, 2014.

(51) Int. Cl. F16C 33/36; F16C 19/30

(52) U.S. Cl. CPC F16C 33/363; F16C 19/305

(57) ABSTRACT

A four segment contact thrust roller bearing is provided having first and second radially extending raceways. A plurality of rollers are located between the first and second raceways, and a cage with pockets hold the rollers spaced apart from one another. The rollers are each split on a circumferential surface thereof to define two separate roller segments that each contact the first and second raceways.

### INCORPORATION BY REFERENCE

The following documents are incorporated herein by reference as if fully set forth: U.S. Provisional Patent Application No. 62/029,716, filed Jul. 28, 2014.

### FIELD OF INVENTION

The present invention relates to a bearing arrangement for thrust or axial loads, and more particularly to a thrust roller bearing with higher moment load carrying capabilities.

### BACKGROUND

Thrust roller bearing arrangements are known, and are particularly useful in many machine design applications. One known application, shown in FIG. 1, is in carrying axial or thrust loads in a torque converter 2 for an automatic transmission. As shown, the torque converter 2 includes a housing 3 in which a hydraulic coupling takes place between the power input from the engine and the input shaft of the transmission. The housing 3 is shown with a first wall section 3a and a second wall section 3b. The second wall section 3b is typically preassembled with pump vanes to form the pump 4. A turbine 5 having turbine vanes is shown connected to a first hub 6. The turbine vanes become hydraulically coupled to the pump vanes in order to rotate the transmission input shaft via the connection of the first hub 6 to the input shaft. A stator 7 is provided between the vanes of the pump 4 and the turbine 5. As can be seen in FIG. 1, thrust roller bearings 8 are located between the second housing section 3b and the stator 7 as well as between the stator 7 and the first hub 6 in order to carry thrust or axial loads. The known thrust roller bearing is shown in detail in FIG. 2, and includes first and second raceways 9, 10, and cylindrical rollers 11 held spaced apart in a cage 12. The rollers 11 provide two line contacts, indicated at 13.

Due to the variations in forces of the hydraulic coupling of the pump 4, turbine 5, and stator 7, moments are also applied to the roller thrust bearings 8 which can cause the components to tilt, adversely affecting the roller thrust bearing life, as well as the functioning of the torque converter 2 due to deflections of the various components, such as the stator 7 and turbine 5.

While one possible solution is to increase the overall bearing diameter of the roller thrust bearings to increase the capacity to handle moment loading, both space and weight are at a premium in modern automotive design.

Accordingly, it would be desirable to provide a roller thrust bearing that addresses these issues which can be used in various different applications, including torque converters, by providing increased capacity for carrying moment loads with higher fatigue limits within the same space and using about the same amount of materials so that the improvement can be realized with minimal additional costs and without the requirement of redesigning other parts used in assemblies requiring such thrust roller bearings, such as torque converters.

### SUMMARY

A four segment contact thrust roller bearing is provided comprising first and second radially extending raceways, a plurality of rollers located between the first and second raceways, a cage with pockets that hold the rollers spaced apart from one another. The rollers are each split on a circumferential surface thereof to define two separate roller segments that each contact the first and second raceways.

In another aspect, the split is formed by a circumferentially extending groove.

In another aspect, the line contacts of the separate roller segments are radially spaced apart.

In another aspect, a distance between the segments is between 2% and 20% of a length of the rollers.

In another aspect, the thrust roller bearing has an increased fatigue life under a same loading condition in comparison to a same sized thrust roller bearing having rollers with an unbroken circumferential surface. It also provides an increased resistance to moment loads.

In another aspect, a torque converter assembly is provided comprising thrust roller bearings as described above located at least one of between a pump and stator or between a turbine and the stator of the torque converter. This provides increased resistance to interference between rotating torque converter components due to moments acting on them and/or a longer service life.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a cross-sectional view through a torque converter in accordance with the prior art.

FIG. 2 is a cross-sectional view through a thrust roller bearing according to the prior art, which has been used, for example, in the torque converter of FIG. 1.

FIG. 3 is a cross-sectional view of an exemplary embodiment of a four segment contact thrust roller bearing.

FIG. 4 is a partial elevational view of the four segment contact thrust roller bearing shown in FIG. 3.

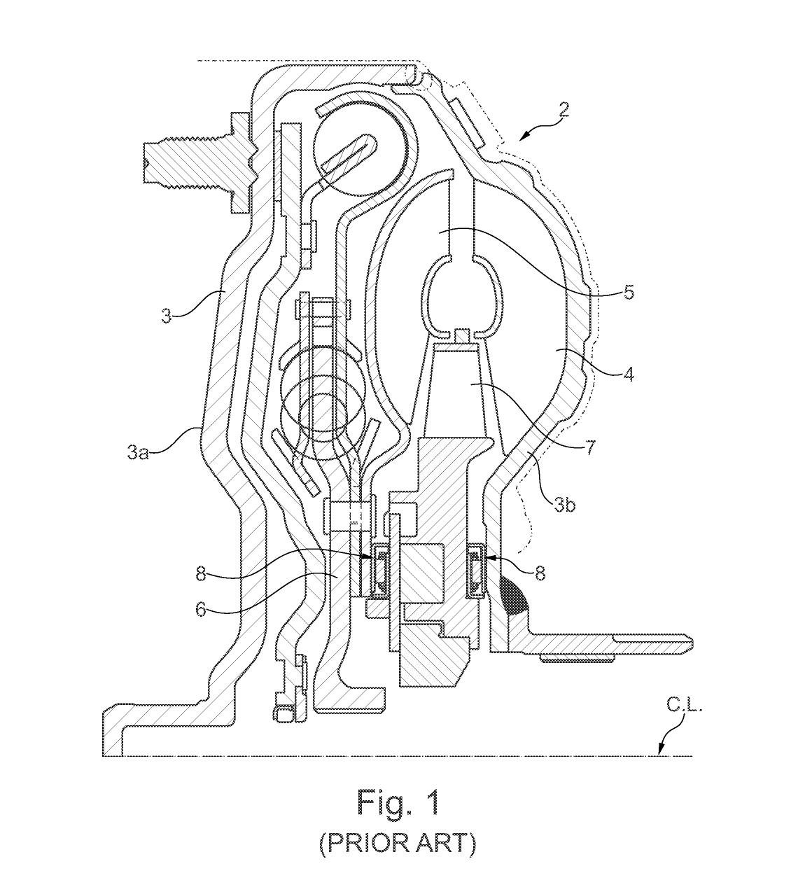

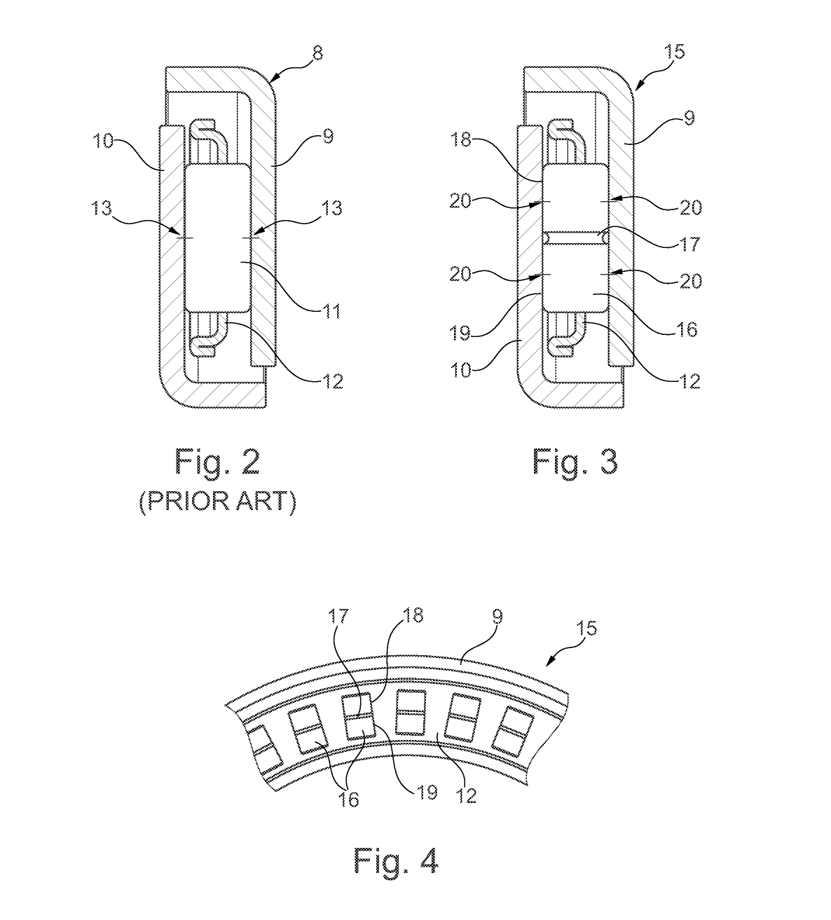

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Referring now to FIGS. 3 and 4, a preferred embodiment of a four segment thrust roller bearing 15 is shown. The four segment thrust roller bearing 15 includes the first and second raceways 9, 10, which are preferably L-shaped in cross-section, as shown. Rollers 16 are located in pockets in the cage 12. The rollers 16 are each split on a circumferential surface thereof, preferably by a groove 17, to define two separate roller segments 18, 19 that each contact the first and second raceways 9, 10. The two separate roller segments 18, 19 produce four line contacts, indicated at 20, with the raceways 9, 10, which are radially spaced apart. A distance between the separate roller segments 18, 19 is preferably between 2% and 20% of a length of the rollers.

In one preferred embodiment, the rollers 16 have a same length and diameter as the rollers 11 in the known prior art roller thrust bearing 8. The rollers 16 are manufactured in the same manner from bearing steel that is machined with the groove 16 before finish grinding and hardening. The inner surface of the groove 17 does not contact the raceways 9, 10, and accordingly does not need any special finishing. This allows assembly of the four segment contact thrust roller bearing 15 in the same manner and at basically the same cost as the prior art thrust roller bearing, in the same size and configuration. However, the thrust roller bearing 15 has an increased fatigue life under a same loading condition in comparison to a same sized thrust roller bearing 8 having rollers 11 with an unbroken circumferential surface. Here the “same size” means that the raceways have the same dimensions and the rollers 16 and prior art rollers 11 have the same overall length and diameter. The materials are also the same.

In one analysis performed by the inventor for a thrust roller bearing 8 having prior art rollers 11 in comparison to the four segment thrust roller bearing 15 having rollers 16, with the rollers 11, 16 having a diameter of 2.25 mm and a length of 5.8 mm, with the only difference being a centrally located groove 17 having a width of 0.8 mm in the rollers 16. Based on the analysis, the fatigue limit load increased marginally, the tilt under load decreased by about 8%, and the calculated life rating increased by about 18% for the four segment thrust roller bearing 15 having the rollers 16. Here, since the contact area is smaller for the rollers 16 in comparison with the prior art rollers 11, the contact stress for the same load increases.

In a further analysis, where the rollers 16 had an increased length so that the effective contact length with the raceways was the same as the rollers 11 (i.e., the length of the rollers 16 was increased by the 0.8 mm groove width), with the remaining conditions being the same, the fatigue limit load increased by about 9% in comparison to the prior art thrust roller bearing 11, the tilt under load decreased by about 13%, and the calculated life rating increased by about 23%. While this would require a small change in the envelope size of the bearing, there is a significant increase in the bearing properties.

The rollers 16 with four segment contact improve the capacity of the bearing 15 to resist moment loads. The farther that the segments 18, 19 are spaced apart, the higher the capacity to resist moments. This improves the overall stiffness of a system using the four segment thrust roller bearings 15, for example in a torque converter 2 with the four segment thrust roller bearings 15 to reduce tilting of the torque converter components. This arrangement also provides the benefits of a double row thrust roller bearing, with increased stiffness due to the use of single rollers 16 having the two separate roller segments 18, 19 that are radially spaced apart from one another. Assembly costs are also lower than double row thrust roller bearings since there is no need to handle separate roller segments.

In a further extension of the invention, multiple segments could be provided on each single roller by having additional spaced apart grooves 17.

Having thus described the presently preferred embodiments in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A thrust roller bearing, comprising
first and second radially extending raceways;
a plurality of rollers located between the first and second raceways;
a cage with pockets that hold the rollers spaced apart from one another;
wherein the rollers are each split on a circumferential surface thereof to define two separate roller segments that each contact the first and second raceways.

2. The thrust roller bearing of claim 1, wherein the split is formed by a circumferentially extending groove.

3. The thrust roller bearing of claim 1, wherein the line contacts of the separate roller segments are radially spaced apart.

4. The thrust roller bearing of claim 1, wherein a distance between the segments is between 2% and 20% of a length of the rollers.

5. The thrust roller bearing of claim 1, wherein the thrust roller bearing has an increased fatigue life under a same loading condition in comparison to a same sized thrust roller bearing having rollers with an unbroken circumferential surface.

6. A torque converter assembly, comprising thrust roller bearings according to claim 1 located at least one of between a pump and stator or between a turbine and the stator.
